(19) United States
(12) Patent Application Publication
(10) Pub. No.: US 2025/0036111 A1
(43) Pub. Date: Jan. 30, 2025

(54) METHOD AND SYSTEM FOR PREDICTING PRODUCT ASSEMBLY QUALITY BASED ON LONGITUDINAL UNIFIED LEARNING

(71) Applicant: GUANGDONG UNIVERSITY OF TECHNOLOGY, Guangzhou (CN)

(72) Inventors: Jiewu LENG, Guangzhou (CN); Rongjie LI, Guangzhou (CN); Caiyu XU, Guangzhou (CN); Yuanwei ZHONG, Guangzhou (CN); Junxing XIE, Guangzhou (CN); Keyou ZHENG, Guangzhou (CN); Qiang LIU, Guangzhou (CN)

(73) Assignee: GUANGDONG UNIVERSITY OF TECHNOLOGY, Guangzhou (CN)

(21) Appl. No.: 18/916,505

(22) Filed: Oct. 15, 2024

(30) Foreign Application Priority Data
Jun. 18, 2024 (CN) 202410785922.1

(51) Int. Cl. G05B 19/418; H04L 9/00

(52) U.S. Cl. CPC G05B 19/41875; H04L 9/008

(57) ABSTRACT

In a method for predicting product assembly quality based on longitudinal unified learning, sample alignment is performed on a data sample of each participant to resolve problems of decentralization, nonuniformity, and scarcity of data; data partitioning is performed by a multi-player parallel structure on product assembly data by using a customized data partitioning policy, layer normalization is firstly performed by an encoder on partitioned data, and feature extraction is performed by a multi-thread attention layer to mine a correlation between each assembly production line inside the participant and assembly data of each device, so that a model feature extraction capability is enhanced; gradient security aggregation is performed on the local model of each participant by using a homomorphic encipherment method of secure multi-player computation, to obtain a global model, so that data of a plurality of sub-factories is merged to co-train a high-precision assembly quality prediction model.

### CROSS-REFERENCE TO RELATED APPLICATIONS

This application claims priority to Chinese Patent Application No. 202410785922.1 with a filing date of Jun. 18, 2024. The content of the aforementioned application, including any intervening amendments thereto, is incorporated herein by reference.

### TECHNICAL FIELD

The present disclosure relates to the technical field of assembly quality prediction, and in particular, relates to a method and a system for predicting product assembly quality based on longitudinal unified learning.

### BACKGROUND

In many manufacturing scenarios, a plurality of manufacturers are required to participate in production of a single product. When an artificial intelligence model is used to predict product assembly quality, a conventional artificial intelligence model usually needs to perform central processing on data of the plurality of manufacturers in a network. In other words, the manufacturers should upload data thereof to a central server to train a learning model. However, due to high data confidentiality requirements of some product services, the manufacturers are unwilling to disclose data information generated during production while providing the services. In view of this, as a distributed machine learning technology, decentralized learning can be used to create a global model by learning from a plurality of disperse edge clients. However, feature data obtained by a same product in different production environments or detection devices is usually different. As a result, sample data features in different product assembly or detection environments are different, but sample IDs are the same, and only the detection party has specific label data. This meets a sample data type of longitudinal unified learning. However, based on characteristics of product assembly data, on one hand, a degree of concentration of the data is low while some enterprises have high data confidentiality requirements, on the other hand, some data features are scarce or unevenly distributed. This poses challenges to model training, and consequently, a corresponding proper model needs to be established for training a high-quality model by combining participants.

### SUMMARY OF PRESENT INVENTION

An objective of the present disclosure is to provide a method and a system for predicting product assembly quality based on longitudinal unified learning, to overcome disadvantages in the prior art.

To achieve the above objective, the present disclosure provides the following technical solution.

A method for predicting product assembly quality based on longitudinal unified learning is provided, including:
performing sample alignment on a data sample of each participant under an encryption policy;
training the aligned data sample of each participant to obtain a local model of the participant, and extracting and aggregating, based on the local model, data features generated by different devices in the corresponding participant;
performing gradient security aggregation on the local model of each participant by using a homomorphic encipherment method of secure multi-player computation, to obtain a global model; and
merging the extracted and aggregated data features generated by different devices in each participant, and training the global model with merged data; and finally predicting the product assembly quality by using the trained global model.

Further, the performing sample alignment on a data sample of each participant under an encryption policy includes: performing homomorphic encipherment operation on the data sample of each participant by using the homomorphic encipherment method, and then performing alignment operation on the data sample in a ciphertext state.

Further, the method includes: subjecting the aligned data sample of each participant to a multi-player parallel structure two rounds in the local model, and extracting and aggregating the data features.

Further, the method includes: performing data partitioning on product assembly data by the multi-player parallel structure by using a customized data partitioning policy, performing layer normalization by an encoder on partitioned data, and performing feature extraction by a multi-thread attention layer to mine a correlation between each assembly production line inside the participant and assembly data of each device for feature extraction.

Further, the customized data partitioning policy includes:
performing partitioning operation on data of a j^{th} key assembly and processing device with a size of Hj×Wj to split data into Nj data patches:

$$\begin{matrix}Nj = HjWj // patch\_size , \\ patch\_size = PHj \cdot PWj ,\end{matrix}$$

where, patch_size is a size of a data patch, both PHj and PWj are respectively determined based on a processing characteristic of the j^{th} key assembly and processing device as a length and a width of the data patch;
adding learnable classification information element_{class} ahead of a data partitioning sequence to obtain a data partitioning sequence with a length of Nj+1; and
inputting the data into a corresponding editor for feature extraction by adopting the customized data partitioning policy for data of each key device in the assembly production line.

To achieve the objective, the present disclosure further provides a system for predicting product assembly quality based on longitudinal unified learning, which is used to implement the method for predicting product assembly quality based on longitudinal unified learning. The system includes a sample alignment module, a bottom-layer module, a unified interaction module, and a top-layer module.

In the system,
the sample alignment module is configured to perform sample alignment on a data sample of each participant under an encryption policy.

The bottom-layer module is configured to: train the aligned data sample of each participant to obtain a local model of the participant, and extract and aggregate, based on the local model, data features generated by different devices in the corresponding participant.

The unified interaction module is configured to: perform gradient security aggregation on the local model of each participant by using a homomorphic encipherment method of secure multi-player computation, to obtain a global model.

The top-layer module is configured to: merge the extracted and aggregated data features generated by different devices in each participant, and train the global model with merged data; and finally predict the product assembly quality by using the trained global model.

Compared with the prior art, the present disclosure has the following principles and advantages.

1. At a data preprocessing stage, sample alignment is performed on the data sample of each participant under the encryption policy, to resolve problems of decentralization, nonuniformity, and scarcity of the data.

2. The local model of each participant adopts the multi-player parallel structure, data partitioning is performed by the multi-player parallel structure on the product assembly data by using the customized data partitioning policy, layer normalization is firstly performed by the encoder on the partitioned data, and feature extraction is performed by the multi-thread attention layer to mine the correlation between each assembly production line inside the participant and the assembly data of each device for feature extraction, so that a model feature extraction capability is enhanced.

3. Gradient security aggregation is performed on the local model of each participant by using the homomorphic encipherment method of secure multi-player computation, to obtain the global model, so that data of a plurality of sub-factories is merged to co-train a high-precision assembly quality prediction model. This integrates credible sharing and primary protection of a plurality of different roles for product service development, thereby assisting decision-making.

### BRIEF DESCRIPTION OF THE DRAWINGS

To describe the technical solutions in the embodiments of the present disclosure or in the prior art more clearly, the following briefly describes the drawings required for describing the embodiments or the prior art. Apparently, the drawings in the following description show merely some embodiments of the present disclosure, and a person of ordinary skill in the art may still derive other drawings from these drawings without creative efforts.

FIG. 1 is a connection block diagram of a system for predicating product assembly quality based on longitudinal unified learning;

FIG. 2 is framework diagram of a local model adopted in a system for predicating product assembly quality based on longitudinal unified learning;

FIG. 3 is a schematic diagram of a relationship between a multi-player parallel structure and a multi-thread attention mechanism; and

FIG. 4 is a schematic diagram of an operation mechanism of a customized data partitioning policy.

### DESCRIPTION OF THE EMBODIMENTS

The present disclosure is described in further detail below according to a specific embodiment.

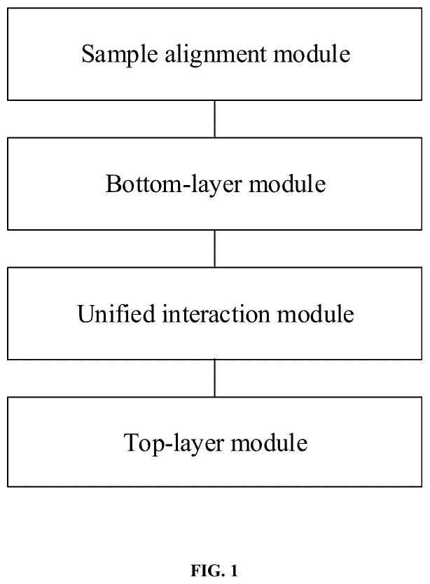

As shown in FIG. 1, a system for predicating product assembly quality based on longitudinal unified learning in this embodiment includes a sample alignment module, a bottom-layer module, a unified interaction module, and a top-layer module.

In the system,
the sample alignment module is configured to perform sample alignment on a data sample of each participant under an encryption policy.

The bottom-layer module is configured to: train the aligned data sample of each participant to obtain a local model of the participant, and extract and aggregate, based on the local model, data features generated by different devices in the corresponding participant.

The unified interaction module is configured to: perform gradient security aggregation on the local model of each participant by using a homomorphic encipherment method of secure multi-player computation, to obtain a global model.

The top-layer module is configured to: merge the extracted and aggregated data features generated by different devices in each participant, and train the global model with merged data; and finally predict the product assembly quality by using the trained global model.

The following shows a working principle of the system.

In the product assembly field of the manufacturing industry, a same product needs to be processed through a plurality of assembly processes or processed and assembled by a plurality of sub-factories. In this case, different participants have different feature data. The same product is processed by different sub-factories, and therefore, a sample overlapping degree of the same product is high. Inevitably, however, feature space of the sample may not be exactly the same, and therefore, a proper method needs to be adopted to process the difference. In view of this, that the sample alignment module is configured to perform sample alignment on a data sample of each participant under an encryption policy includes: performing homomorphic encipherment operation on the data sample of each participant by using a homomorphic encipherment method, and then performing alignment operation on the data sample in a ciphertext state.

Then, the bottom-layer module is configured to: train the aligned data sample to obtain a local model of each participant, and extract and aggregate, based on the local model, data features generated by different devices in the corresponding participant.

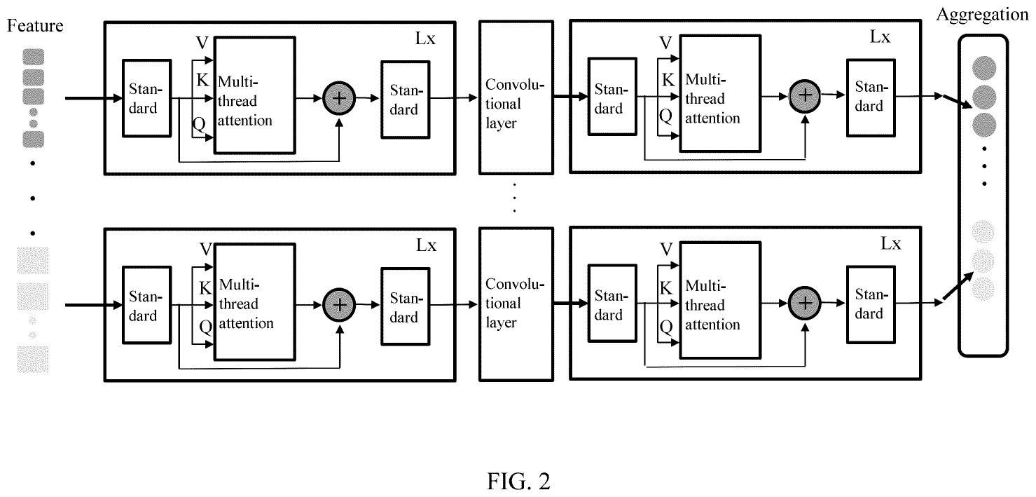

In this step, a framework of the local model is as shown in FIG. 2.

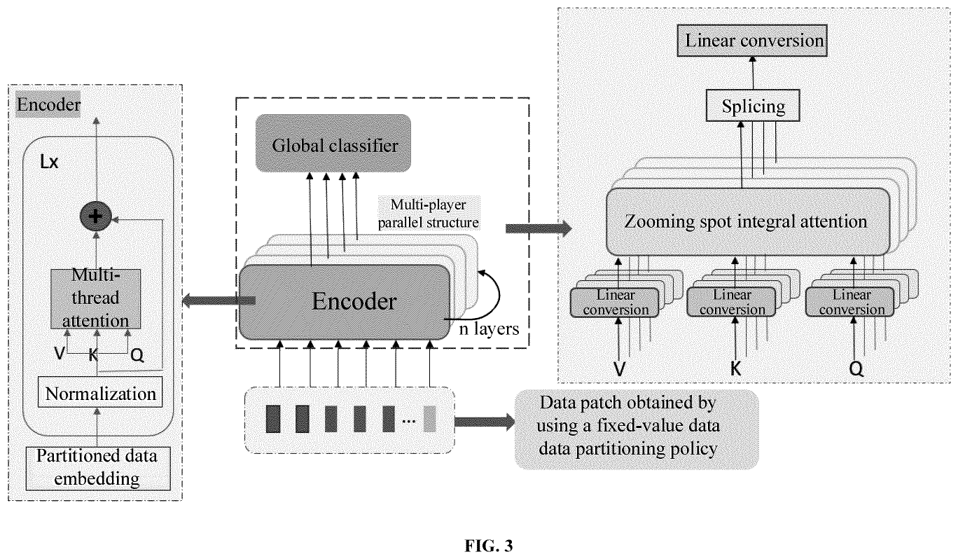

The data sample is firstly extracted by the encoder, and then feature extraction is performed by the part on product assembly quality data by using the multi-thread attention mechanism. A relationship between the multi-player parallel structure and the multi-thread attention mechanism is as shown in FIG. 3.

A body part of the local model and a global classifier of the local model can be merged together and simplified as the multi-thread attention mechanism. The multi-thread attention mechanism may be a method for mapping a query vector Q and a set of key K-V pairs to obtain an output vector. Based on a characteristic of a key device in each assembly step, in this embodiment, data partitioning is performed on assembly data in a multi-player parallel manner by using a customized data partitioning policy, layer normalization is firstly performed by an encoder on partitioned data, and feature extraction is performed by a multi-thread attention layer to mine a correlation between each assembly production line inside the participant and assembly data of each device, to implement a strong feature extraction function of a neural network.

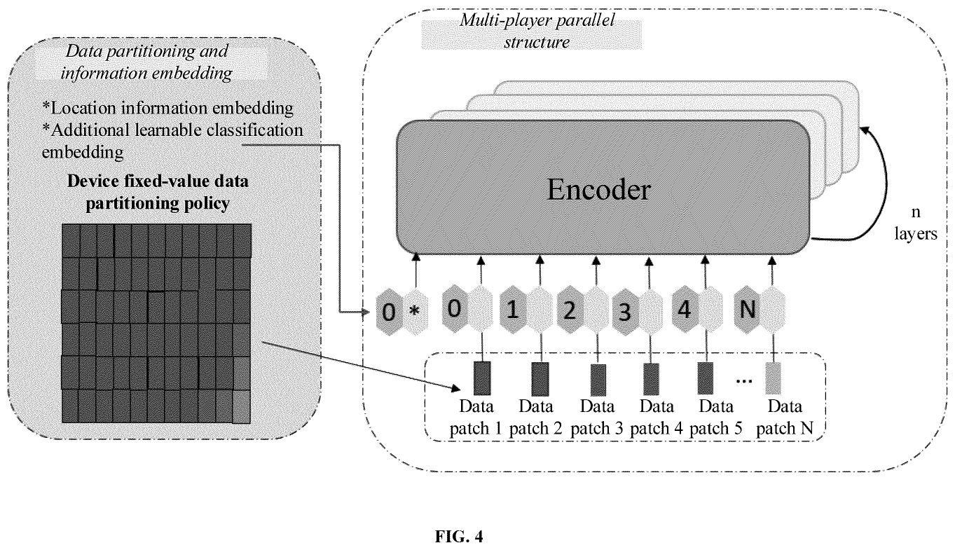

As shown in FIG. 4, the customized data partitioning policy includes the following.

Partitioning operation is performed on data of a j^{th} key assembly and processing device with a size of Hj×Wj, to split data into Nj data patches:

$$\begin{matrix}Nj = HjWj // patch\_size , \\ patch\_size = PHj \cdot PWj ,\end{matrix}$$

where, patch_size is a size of a data patch, both PHj and PWj are respectively determined based on a processing characteristic of the j^{th} key assembly and processing device as a length and a width of the data patch;

Learnable classification information element_{class} is added ahead of a data partitioning sequence to obtain a data partitioning sequence with a length of Nj+1; and
the data is input into a corresponding editor for feature extraction by adopting the customized data partitioning policy for data of each key device in the assembly production line.

Then, gradient security aggregation is performed by the unified interaction module on the local model of each participant by using a homomorphic encipherment method of secure multi-player computation, to obtain a global model.

In this step, as some enterprises or manufacturers have high data confidentiality requirements, encryption needs to be processed before model aggregation. The multi-player security computation in longitudinal unified learning is a computation model that emphasizes data privacy and security. It allows the participant to cooperate in computation without exposing private information, and therefore, it is a method capable of effectively processing a privacy problem. Each sub-factory, namely, a multi-device feature of each participant is aggregated in a local model of the sub-factory and then is transferred into the unified interaction module. Then, gradient security aggregation is performed on the local model of each participant by using the homomorphic encipherment method of secure multi-player computation, to obtain a global model without sharing original data. In this way, a higher level of data privacy and security is achieved.

Finally, the extracted and aggregated data features generated by different devices in each participant are merged by the top-layer module, and the global model is trained with merged data; and finally, the product assembly quality is predicted by using the trained global model.

The above described are only preferred embodiments of the present disclosure, and are not intended to limit the implementation scope of the present disclosure. Therefore, all changes made in accordance with the shapes and principles of the present disclosure should fall within the protection scope of the present disclosure.

What is claimed is:

1. A method for predicting product assembly quality based on longitudinal unified learning, comprising:
performing sample alignment on a data sample of each participant under an encryption policy;
training the aligned data sample of each participant to obtain a local model of the participant, and extracting and aggregating, based on the local model, data features generated by different devices in the corresponding participant;
performing gradient security aggregation on the local model of each participant by using a homomorphic encipherment method of secure multi-player computation, to obtain a global model; and
merging the extracted and aggregated data features generated by different devices in each participant, and training the global model with merged data; and finally predicting the product assembly quality by using the trained global model.

2. The method according to claim 1, wherein the performing sample alignment on a data sample of each participant under an encryption policy comprises: performing homomorphic encipherment operation on the data sample of each participant by using the homomorphic encipherment method, and then performing alignment operation on the data sample in a ciphertext state.

3. The method according to claim 1, comprising subjecting the aligned data sample of each participant to a multi-player parallel structure two rounds in the local model, and extracting and aggregating the data features.

4. The method according to claim 3, comprising performing data partitioning on product assembly data by the multi-player parallel structure by using a customized data partitioning policy, performing layer normalization by an encoder on partitioned data, and performing feature extraction by a multi-thread attention layer to mine a correlation between each assembly production line inside the participant and assembly data of each device for feature extraction.

5. The method according to claim 4, wherein the customized data partitioning policy comprises:
performing partitioning operation on data of a j^{th} key assembly and processing device with a size of Hj×Wj to split data into Nj data patches:
$$\begin{matrix}Nj = HjWj // patch\_size , \\ patch\_size = PHj \cdot PWj ,\end{matrix}$$
wherein, patch_size is a size of a data patch, both PHj and PWj are respectively determined based on a processing characteristic of the j^{th} key assembly and processing device as a length and a width of the data patch;
adding learnable classification information element_{class} ahead of a data partitioning sequence to obtain a data partitioning sequence with a length of Nj+1; and
inputting the data into a corresponding editor for feature extraction by adopting the customized data partitioning policy for data of each key device in the assembly production line.

6. A system for predicting product assembly quality based on longitudinal unified learning, used to implement the method for predicting product assembly quality based on longitudinal unified learning according to claim 1, wherein the system comprises a sample alignment module, a bottom-layer module, a unified interaction module, and a top-layer module,
wherein,
the sample alignment module is configured to perform sample alignment on a data sample of each participant under an encryption policy;
the bottom-layer module is configured to: train the aligned data sample of each participant to obtain a local model of the participant, and extract and aggregate, based on the local model, data features generated by different devices in the corresponding participant;
the unified interaction module is configured to: perform gradient security aggregation on the local model of each participant by using a homomorphic encipherment method of secure multi-player computation, to obtain a global model; and
the top-layer module is configured to: merge the extracted and aggregated data features generated by different devices in each participant, and train the global model with merged data; and finally predict the product assembly quality by using the trained global model.
